(19) United States
(12) Patent Application Publication
(10) Pub. No.: US 2009/0213250 A1
(43) Pub. Date: Aug. 27, 2009

(54) Internal Storage of Camera Characteristics During Production

(75) Inventors: Juha Alakarhu, Helsinki (FI); Eero Salmelin, Tampere (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: NOKIA CORPORATION, Espoo (FI)

(21) Appl. No.: 11/992,242

(22) PCT Filed: Sep. 28, 2005
(86) PCT No.: PCT/IB2005/002875

§ 371 Date: Apr. 27, 2009

(51) Int. Cl. H04N 9/64

(52) U.S. Cl. 348/243; 348/247

(57) ABSTRACT

The specification and drawings present a new method, apparatus and software product for storing camera module characteristics of a camera module (or camera) of an electronic device provided during production (e.g., a factory testing) of the electronic device in a non-volatile memory of the camera module, such that the camera module characteristics are used by the electronic device for taking and processing images and/or identifying the camera module. The electronic device can be a wireless communication device, a portable electronic device, a camera, a camera-phone mobile device, etc.

### TECHNICAL FIELD

The present invention relates generally to video electronic devices and, more specifically, to storing camera module characteristics during production.

### BACKGROUND ART

An image sensor (or a sensor) is a light sensitive element in any digital camera. The core of the sensor is an array of pixels. The output, value of each pixel is proportional to the energy of light incident on that pixel, enabling the sensor to output an image. Color imaging is possible by placing a color filter in front of each pixel.

Typically, the sensor has non-ideal characteristics: e.g., pixels can generate output signal even in the dark, pixels have limited capacity (get saturated), the relationship between light energy and output value is not the same for all pixels, and pixels have a different color response. There are also pixels that have a fixed value response. Further parameters are introduced by placing an optical system in front of the sensor: difference in a level of sharpness and darkening of image parts that further away from an optical axis (vignetting).

The characteristics can be divided into temporal and spatial classes. The temporal characteristics refer to properties of an individual pixel, such as temporal noise. The spatial characteristics refer to differences between pixels in a given sensor. Sensor can also have sensor-specific parameters, which include the serial number, manufacturing time, and color matrix. The color matrix is used to convert a sensor color space to a common/known color space, such as RGB.

The problem of parameters that change spatially in the image array and sensor-specific parameters can degrade the image quality. The phenomenon of spatially changing parameters is called a spatial noise. The sensor-specific parameters are typically the same for all pixels of the same sensor but vary from sensor to sensor. Each pixel generates a dark current but at a different rate: the difference between different pixels can be even an order of magnitude. This can be a problem especially in low light conditions. The noise due to a different dark current generation rate is called a dark signal non-uniformity (DSNU). The DSNU can be compensated by using a mechanical shutter and taking dark frames after taking each image. This is not possible for imaging devices that do not have a mechanical shutter or for sensor arrangements that do not have access to a mechanical shutter, e.g., in a production environment before an imaging product has been assembled.

The proportion between the pixel output and incident light energy can be also different for different pixels, i.e., the pixels can be considered to have different gains. This is a problem especially in bright and moderate light conditions. This type of spatial noise is called a photoresponse non-uniformity (PRNU). A typical value for the PRNU is 1%=(average deviation/average pixel value)*100%. So far, there has not been a camera module (or an image sensor) which can include a programmable non-volatile memory such that the memory has to reside inside a camera module to be able to apply a calibration during the factory testing. Therefore, prior art compensation techniques use external memories and that is why a PRNU compensation has not been widely applied earlier.

Due to vignetting, the absolute pixel output in the corners of the image can be only 25%-50% of the pixel output in the optical axis, even with uniform illumination. This effect can be partially compensated by digital processing, but it has not been done for each sensor individually. The vignetting can be compensated by applying more gain the further away the pixels are from an optical axis, but it has not been calculated for individual camera modules.

The blur due to optics is typically partially compensated by sharpening the image by digital processing. However, the compensation has not been sensor-specific. Therefore, the images from two cameras of a same model can look different.

Similarly, the same color matrix has been used for all cameras of the same model. However, this causes differences in colors because the cameras have not been individually calibrated.

### DISCLOSURE OF THE INVENTION

According to a first aspect of the invention, a method for storing camera module characteristics of a camera module of an electronic device, comprises: providing, during production, the camera module characteristics comprising at least one of:

a) pixel calibration data for pixels of an image sensor of the camera module,

b) sensor-specific parameters, and

c) a delay of a mechanical shutter; and

storing, during the production, the camera module characteristics in a non-volatile memory build-in within the camera module such that the camera module characteristics are used by the electronic device for taking and processing images or for identifying the camera module.

According further to the first aspect of the invention, the pixel calibration data may comprise at least one of: a dark current calibration, a photoresponse-nonuniformity calibration and a vignetting calibration, and the providing of the pixel calibration data comprises the steps of: generating pixel characterization data comprising at least one of: a dark current characterization, a photoresponse-nonuniformity characterization and a vignetting characterization for the pixels of the image sensor of the camera module; and processing the pixel characterization data for generating the at least one of: the dark current calibration, the photoresponse-nonuniformity calibration and the vignetting calibration, respectively. Further, the generating by the electronic device for each pixel of the image sensor during the taking of the images further pixel characterization data may comprise at least one of: a further dark current characterization, a further photocurrent characterization and a further vignetting characterization; processing by the electronic device the further pixel characterization data for generating further pixel calibration data; and storing the further pixel calibration data in the non-volatile memory such that the further pixel calibration data may be used for correcting further images taken by the electronic device using the image sensor. Still further, the current dark current characterization data may be provided for different operation conditions of the camera module according to a preselected criterion. Yet still further, the different operation conditions may be different temperatures or different exposure times. Still yet further, the vignetting characterization data may be provided using different distances from images or using different positions of optical components comprising a focusing optics assembly placed in front of the image sensor.

Further according to the first aspect of the invention, the camera module characteristics, stored in the non-volatile memory during the production, may further comprise at least one of:

a) a camera module identification,

b) a manufacturing date,

c) a color correction matrix of the image sensor and

d) an image sharpening.

Still further according to the first aspect of the invention, the delay may be used for adjusting timing of the shutter when the images are taken by the electronic device. Further, the invention may comprise the step of: recording, during the taking of the images, a further delay of a mechanical shutter and storing the further delay in the non-volatile memory such that the further delay is used for adjusting timing of the shutter when further images are taken by the electronic device.

According further to the first aspect of the invention, the image sensor and the non-volatile memory may be integrated in one integrated circuit.

According still further to the first aspect of the invention, the method may comprise the steps of: generating a video signal from a desired video image using the image sensor; and further processing the video signal using calibration data selected from the pixel calibration data stored in the non-volatile memory using a predetermined criterion for correcting the video signal and generating a corrected video signal.

According further still to the first aspect of the invention, the method may comprise the step of: storing the corrected video signal in a further memory.

According to a second aspect of the invention, a computer program product comprises: a computer readable storage structure embodying computer program code thereon for execution by a computer processor with the computer program code characterized in that it includes instructions for performing the steps of the first aspect of the invention indicated as being performed by any component of the electronic device.

According to a third aspect of the invention, an electronic device, comprises: a camera module comprising an image sensor; a processing block, for providing, during production, camera module characteristics comprising at least one of:

a) pixel calibration data for pixels of an image sensor of the camera module,

b) sensor-specific parameters, and

c) a delay of a mechanical shutter; and

a non-volatile memory, for storing, during the production, the camera module characteristics such that the camera module characteristics are used by the electronic device for taking and processing images or for identifying the camera module, wherein the non-volatile memory is build-in within the camera module.

According further to the third aspect of the invention, the camera module may comprise the processing block.

Further according to the third aspect of the invention, the pixel calibration data may comprise at least one of: a dark current calibration, a photoresponse-nonuniformity calibration and a vignetting calibration, and the providing the pixel calibration data comprises: generating, using the image sensor, pixel characterization data comprising a dark current characterization, a photoresponse-nonuniformity characterization and a vignetting characterization for the pixels of the image sensor of the camera module; and processing by the processing block the pixel characterization data for generating the at least one of: the dark current calibration, the photoresponse-nonuniformity calibration and the vignetting calibration, respectively.

Still further according to the third aspect of the invention, the camera module characteristics, stored in the non-volatile memory during the production, may further comprise at least one of:

a) a camera module identification,

b) a manufacturing date

c) a color correction matrix of the image sensor and

d) an image sharpening.

According further to the third aspect of the invention, the delay may be used for adjusting timing of the shutter when the images are taken by the electronic device.

According still further to the third aspect of the invention, the image sensor and the non-volatile memory may be integrated in one integrated circuit.

According yet further still to the third aspect of the invention, a video signal may be generated from a desired video image using the image sensor; and the video signal is further processed by the processing block using calibration data selected from the pixel calibration data stored in the non-volatile memory using a predetermined criterion for correcting the video signal and generating a corrected video signal.

According yet further still to the third aspect of the invention, the electronic device may be a wireless communication device, a portable electronic device, a camera or a camera-phone mobile device.

According to a fourth aspect of the invention, an integrated circuit, may comprise: an image sensor; a non-volatile memory, for storing, during the production, camera module characteristics such that the camera module characteristics are used for taking and processing images using the image sensor, wherein the camera module characteristics comprise pixel calibration data, the data comprising at least a dark current calibration a photoresponse-nonuniformity calibration and a vignetting calibration for pixels of the image sensor.

### BRIEF DESCRIPTION OF THE DRAWINGS

FIG. 1 is a block diagram of an electronic device for storing pixel calibration data of an image sensor of an electronic device during production for further correcting images taken by the electronic device using the image sensor, according to embodiments of the present invention; and

FIG. 2 is a flow chart demonstrating calibration and image taking procedures by an electronic device, wherein camera module characteristics are stored during production, according to embodiments of the present invention.

### MODES FOR CARRYING OUT THE INVENTION

A new method, apparatus and software product are presented for storing camera module characteristics of a camera module (or camera) of an electronic device provided during production (e.g., a factory testing) of the electronic device in a non-volatile memory of the camera module, such that the camera module characteristics are used by the electronic device for taking and processing images, according to embodiments of the present invention. The electronic device can be a wireless communication device, a portable electronic device, a camera, a camera-phone mobile device, etc.

According to an embodiment of the present invention, the camera module characteristics can comprise pixel calibration data for pixels of an image sensor of the camera module. The pixel calibration data comprises (but not limited to) at least a dark current calibration, a photoresponse-nonuniformity calibration and/or a vignetting calibration.

According to a further embodiment of the present invention, providing the pixel calibration data comprises of: generating, using the image sensor, the pixel characterization data comprising a dark current characterization, a photoresponse-nonuniformity characterization and/or a vignetting characterization for all pixels of the image sensor; and the pixel characterization data is used for generating the pixel calibration data (e.g., the dark current calibration, the photoresponse-nonuniformity calibration and/or the vignetting calibration, respectively) by a processing block of the camera module or by the processing block of the electronic device (i.e., the processing block of the camera module can be incorporated in the processing block of the electronic device).

According to an embodiment of the present invention, the pixel calibration data stored during the production can be updated by providing (using generating and processing as described above) and storing further pixel calibration data in the non-volatile memory during taking of the images, such that the further pixel calibration data can be used for correcting further images taken by the electronic device using the image sensor.

Further, according to embodiments of the present invention, the camera module characteristics can be sensor-specific parameters which can be stored in the non-volatile memory during the production of the electronic device. These sensor-specific parameters can comprise (but are not limited to): a) a camera module identification, e.g., a serial number, which can be a 64 bit or 32 bit binary value, b) a manufacturing date, e.g., a 32 bit number stating the number of seconds from a given reference time, c) a color correction matrix of the image sensor, and/or d) image sharpening. Color matrix can be a 3×3 matrix and this matrix could be generated, e.g., by taking a test image of a known color target during production test and calculating compensating values to color matrix based on a difference of the reproduced color and an ideal color. Also, an image produced by a focusing optics assembly can be not equally sharp on the image area and varies from one camera module to another due to manufacturing tolerances. To overcome this problem, the module-specific image sharpening data can be stored during the production and then used for sharpening the image taken by the camera module. Both manufacturing date/time and serial number can be used to track the camera module after production.

Further, according to embodiments of the present invention, the camera module characteristics, stored during the production, may further comprise a delay of a mechanical shutter, wherein the delay can be used for adjusting timing of the shutter when the images are taken by the electronic device. The delay can be recalibrated during taking of the images: a further delay of the mechanical shutter can be recorded and stored in the non-volatile memory such that the further delay (and not the initial delay recorded during the production) can be alternatively used for adjusting the timing of the shutter when further images are taken by the electronic device.

Further, according to embodiments of the present invention, the image sensor and the non-volatile memory can be integrated in one integrated circuit (e.g., a sensor chip). The integrated memory solution enables small system size. It also enables the camera module characteristics to be stored during the production testing. As the camera module is characterized during the factory testing, individual parameters can be stored for each module and better image quality can be obtained. The image sensor can use any available technology, e.g., a complimentary metal oxide semiconductor (CMOS) imaging array, CCD or similar. The non-volatile memory can utilize available manufacturing methods, including but not be limited to using a CMOS logic process, a flash memory technology, etc. Memory manufacturing in a standard commercial CMOS logic process allows it to be integrated with CMOS image sensors.

According to embodiments of the present invention, the dark current characterization data can be provided for different operation conditions of the camera module according to a preselected criterion, e.g., different temperatures or different exposure times. Furthermore, the vignetting characterization data can be provided using different distances from images or using different positions (e.g., if moving optics is used) of optical components comprising a focusing optics assembly (placed in front of the image sensor).

According to further embodiments of the present invention, when a video signal is generated from a desired video image using the image sensor, the video signal is further processed using calibration data selected from the pixel calibration data stored in the non-volatile memory using a predetermined criterion for correcting the video signal and generating a corrected video signal. The corrected video signal can be optionally stored in an external memory or forwarded to a desired destination.

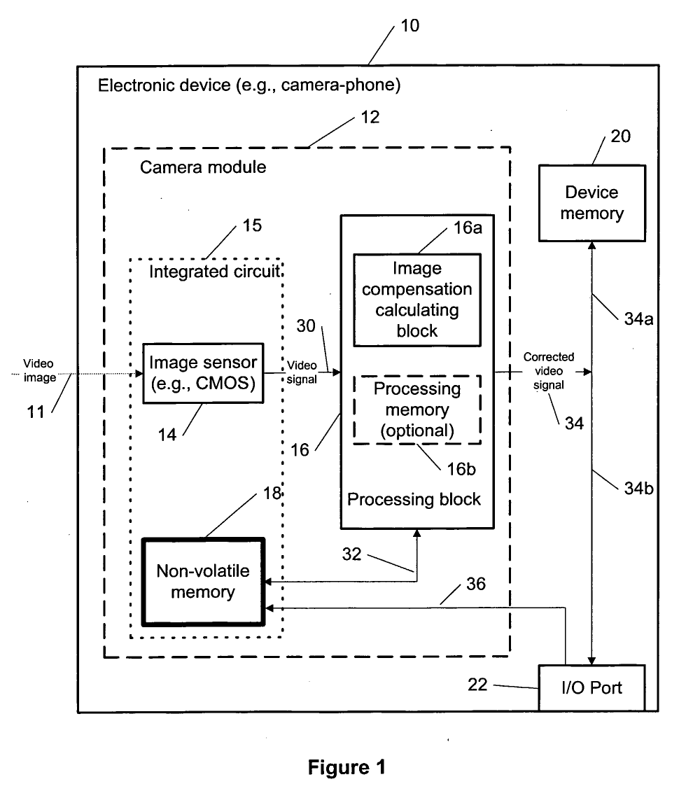

FIG. 1 shows an example among others of a block diagram of an electronic device 10 for storing pixel calibration data of an image sensor 14 of an electronic device 10 during production for further correcting images taken by the electronic device 10 using said image sensor 14, according to embodiments of the present invention.

The camera module 12 comprises an image sensor 14 (e.g., the CMOS sensor) and a non-volatile memory 18 which are integrated on one integrated circuit (e.g., a sensor chip) 15. The camera module 12 further comprises a processing block 16 which can comprise an image compensation calculating block 16a and an optional processing memory 16b to support calculations performed by the block 16 or 16a. The blocks 16 can be a dedicated block in the camera module 12 or it can be incorporated within the processing block of the electronic device 10.

During the production, the image sensor 14 can generate the pixel characterization data comprising a dark current characterization data, a photoresponse-nonuniformity characterization data and/or a vignetting characterization data for the pixels of the image sensor 14. The pixel characterization data is processed by the block 16 (e.g., using the image compensation calculating block 16a) for generating the pixel calibration data (e.g., the dark current calibration, the photoresponse-nonuniformity calibration and/or the vignetting calibration, respectively) which is then stored in the non-volatile memory 18.

The camera module characteristics which are sensor-specific parameters, such as the camera module 12 identification (e.g., a serial number) a manufacturing date and/or a color correction matrix of the image sensor 14 can be also stored in the non-volatile memory 18 during the production of the electronic device 10. The delay of a mechanical shutter (not shown in FIG. 1) can be also recorded and stored during the production in the non-volatile memory 18, wherein the delay can be used for adjusting the timing of the shutter when the images are taken by the electronic device 10. More details about generating the pixel calibration data, camera module characteristics and the delay of a mechanical shutter are described above.

When a video signal 30 is generated from a desired video image 11 using the image sensor 14, the video signal 30 is further processed by the block 16 (or the block 16a) using calibration data selected from the pixel calibration data stored in the non-volatile memory 18 using a predetermined criterion for correcting the video signal 30 and generating a corrected video signal 34. The corrected video signal 34 can be optionally stored in a device memory 20 (or an external memory) or forwarded to a desired destination through the I/O port 22.

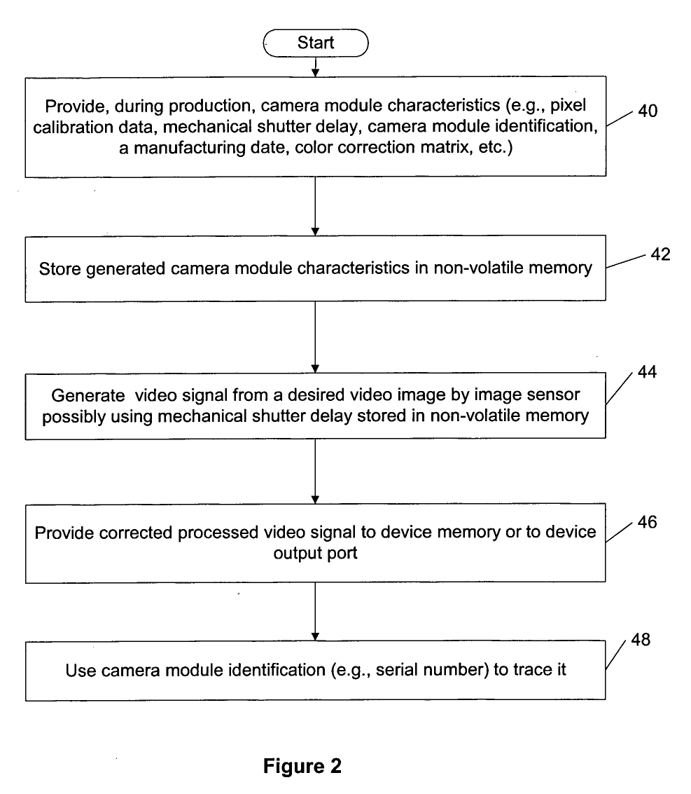

FIG. 2 shows an example of a flow-chart demonstrating calibration and image taking procedures by an electronic device 10, wherein the camera module characteristics are stored during the production in the non-volatile memory 18, according to embodiments of the present invention.

The flow chart of FIG. 2 only represents one possible scenario among others. In a method according to an embodiment of the present invention, in a first step 40, the camera module characteristics (e.g., the pixel calibration data, mechanical shutter delay, sensor-specific parameters, etc.) are provided during production of the electronic device 10, as described above in regard to FIG. 1. According to embodiments of the present invention, the pixel calibration data may include but not be limited to the dark current calibration (e.g., for different temperatures and operation conditions), the photoresponse-nonuniformity calibration, the vignetting calibration (e.g., for different optics positions and image distances), etc. Furthermore, the sensor-specific parameters can comprise (but are not limited to) the camera module identification, the manufacturing date, the color correction matrix of the image sensor, the image sharpening, etc. In a next step 42, the provided camera module characteristics are stored (during production, e.g., testing) in the non-volatile memory 18.

In a next step 44, the video signal 30 is generated from the desired video image 11 by the image sensor 14 possibly using the mechanical shutter delay stored in the non-volatile memory 18 according to the embodiment of the present invention. In a next step 44, the video signal 30 is corrected in a processing block 16 and a corrected video signal 34 is provided to the device memory 20 (or the external memory) or forwarded to a desired destination through the P/O port 22. In a final step 48, the camera module identification (e.g., the serial number) is used to trace it if necessary (if there is, e.g., a problem in the production, the devices having the problem can be identified).

As explained above, the invention provides both a method and corresponding equipment consisting of various modules providing the functionality for performing the steps of the method. The modules may be implemented as hardware, or may be implemented as software or firmware for execution by a computer processor. In particular, in the case of firmware or software, the invention can be provided as a computer program product including a computer readable storage structure embodying computer program code (i.e., the software or firmware) thereon for execution by the computer processor.

It is to be understood that the above-described arrangements are only illustrative of the application of the principles of the present invention. Numerous modifications and alternative arrangements may be devised by those skilled in the art without departing from the scope of the present invention, and the appended claims are intended to cover such modifications and arrangements.

What is claimed is:

1. A method, comprising:
providing, during production, camera module characteristics of a camera module, said characteristics comprising a delay of a mechanical shutter; and
storing, during said production, said camera module characteristics in a non-volatile memory build-in within the camera module.

2. The method of claim 1, wherein said camera module characteristics further comprise at least one of:
pixel calibration data for pixels of an image sensor of said camera module, and
sensor-specific parameters.

3. The method of claim 2, wherein said pixel calibration data comprise at least one of: a dark current calibration, a photoresponse-nonuniformity calibration and a vignetting calibration, and said providing of said pixel calibration data comprises:
generating pixel characterization data comprising at least one of: a dark current characterization, a photoresponse-nonuniformity characterization and a vignetting characterization for said pixels of said image sensor of said camera module; and
processing said pixel characterization data for generating said at least one of: the dark current calibration, the photoresponse-nonuniformity calibration and the vignetting calibration, respectively.

4. The method of claim 3, further comprising:
generating for each pixel of said image sensor during said taking of said images further pixel characterization data comprising at least one of: a further dark current characterization, a further photocurrent characterization and a further vignetting characterization;
processing said further pixel characterization data for generating further pixel calibration data; and
storing said further pixel calibration data in said non-volatile memory such that said further pixel calibration data is used for correcting further images.

5. The method of claim 3, wherein the current dark current characterization data is provided for different operation conditions of the camera module according to a preselected criterion.

6. The method of claim 5, wherein said different operation conditions are different temperatures or different exposure times.

7. The method of claim 3, wherein said vignetting characterization data is provided using different distances from images or using different positions of optical components comprising a focusing optics assembly placed in front of said image sensor.

8. The method of claim 1, wherein said camera module characteristics, stored in the non-volatile memory during said production, further comprise at least one of:
a camera module identification,
a manufacturing date,
a color correction matrix of an image sensor and
an image sharpening.

9. The method of claim 1, wherein said delay is used for adjusting timing of the shutter when said images are taken.

10. The method of claim 9, further comprising:
recording, during said taking of said images, a further delay of a mechanical shutter and storing said further delay in said non-volatile memory such that said further delay is used for adjusting timing of said shutter when further images are taken.

11. The method of claim 1, wherein an image sensor and said non-volatile memory are integrated in one integrated circuit.

12. The method of claim 2, further comprising:
generating a video signal from a desired video image using an image sensor; and
further processing said video signal using calibration data selected from said pixel calibration data stored in said non-volatile memory using a predetermined criterion for correcting said video signal and generating a corrected video signal.

13. The method of claim 12, further comprising:
storing said corrected video signal in a further memory.

14. A computer program product comprising: a computer readable storage structure embodying computer program code thereon for execution by a computer processor with said computer program code, wherein said computer program code comprises instructions for performing the method of claim 1.

15. An apparatus, comprising:
a camera module;
a processing block, configured to provide, during production, camera module characteristics comprising a delay of a mechanical shutter; and
a non-volatile memory, configured to store, during said production, said camera module characteristics, wherein said non-volatile memory is build-in within the camera module.

16. The apparatus of claim 15, wherein said camera module characteristics further comprise at least one of:
pixel calibration data for pixels of an image sensor of said camera module, and
sensor-specific parameters.

17. The apparatus of claim 15, wherein said camera module comprises the processing block.

18. The apparatus of claim 16, wherein said pixel calibration data comprise at least one of: a dark current calibration, a photoresponse-nonuniformity calibration and a vignetting calibration, and wherein
said image sensor is configured to generate pixel characterization data comprising a dark current characterization, a photoresponse-nonuniformity characterization and a vignetting characterization for said pixels of said image sensor of said camera module; and wherein said processing block is configured to process said pixel characterization data for generating said at least one of: the dark current calibration, the photoresponse-nonuniformity calibration and the vignetting calibration, for providing said pixel calibration data.

19. The apparatus of claim 15, wherein said camera module characteristics, stored in the non-volatile memory during said production, further comprise at least one of:
a camera module identification,
a manufacturing date,
a color correction matrix of an image sensor of the camera module, and
an image sharpening.

20. The apparatus of claim 15, wherein said apparatus is configured to use said delay for adjusting timing of the shutter when said images are taken by the apparatus.

21. The apparatus of claim 15, wherein an image sensor of said camera module and said non-volatile memory are integrated in one integrated circuit.

22. The apparatus of claim 16, wherein said apparatus is configured to generate a video signal from a desired video image using the image sensor of said camera module; and said video signal is further processed by the processing block using calibration data selected from said pixel calibration data stored in said non-volatile memory using a predetermined criterion for correcting said video signal and generating a corrected video signal.

23. The apparatus of claim 15, wherein said apparatus is configured for a wireless communications.

24. An integrated circuit, comprising:
an image sensor;
a non-volatile memory, configured to store, during production, camera module characteristics such that said camera module characteristics are for taking images, processing images, taking and processing images or for identifying a camera module, wherein
said camera module characteristics comprise a delay of a mechanical shutter.

25. An integrated circuit of claim 24, wherein said module characteristics c further comprise pixel calibration data, said data comprising at least one of: a dark current calibration, a photoresponse-nonuniformity calibration and a vignetting calibration for pixels of said image sensor.

26. An apparatus, comprising;
means for taking pictures;
means for processing, for providing, during production, characteristics of said means for taking pictures comprising a delay of a mechanical shutter; and
means for storing, during said production, said characteristics, wherein said memory means is build-in within the means for taking pictures.

27. The apparatus of claim 26, wherein said means for storing is a non-volatile memory and means for taking pictures is a camera module.

28. The method of claim 2, wherein said camera module characteristics are for taking images, processing images, taking and processing images or for identifying said camera module.

29. The apparatus of claim 15, wherein said apparatus is configured to use said characteristics for taking images, processing images, taking and processing images or for identifying said camera module.

30. The apparatus of claim 26, wherein said apparatus is configured to use said characteristics for taking images, processing images, taking and processing images or for identifying said camera module.
